(19) United States
(12) Patent Application Publication
(10) Pub. No.: US 2006/0159795 A1
(43) Pub. Date: Jul. 20, 2006

(54) Microwave stiffening system for ceramic extrudates

(76) Inventors: Richard Bergman, Horseheads, NY (US); Jacob George, Corning, NY (US); Harold D. Kimrey JR., Knoxville, TN (US); Mark S. K. Muktoyuk, Corning, NY (US); Rebecca L. Schulz, Horseheads, NY (US); Elizabeth M. Vileno, Corning, NY (US)

Correspondence Address: CORNING INCORPORATED, SP-TI-3-1, CORNING, NY, 14831, US

(21) Appl. No.: 11/378,073

(22) Filed: Mar. 16, 2006

Related U.S. Application Data
(62) Division of application No. 10/699,008, filed on Oct. 31, 2003.

(51) Int. Cl. B29C 35/08

(52) U.S. Cl. 425/174.6

(57) ABSTRACT

An apparatus and method for stiffening an wet extruded ceramic body for improved handling prior to drying and firing. The ceramic body is formed from a plastically deformable material including inorganic raw materials, and organics, such as a binder having a thermal gel point. As the ceramic body log exits the extruder die it is passed through a microwave energy field to be heated to above the gelling point of the organic binder. The ceramic body then stiffens and can be easily handled without deformation.

### BACKGROUND OF THE INVENTION

The present invention relates to a processing system and method for stiffening an extruded body using microwave energy to provide improved handling and to reduce handling-related deformation defects prior to drying and firing operations. More particularly the invention facilitates continuous microwave heating of a wet ceramic extrudate as it is formed into a honeycomb type article.

The extrusion of plasticized material mixtures into multicellular (i.e., honeycomb) bodies involves a delicate balance of softness/deformability (for shape molding) and structural integrity (for shape retention). Such mixtures include inorganic ceramic powders, a binder system and a liquid component, the amounts of which are tightly controlled to maintain low pressure/torque/temperature during the extrusion process while creating a self-supporting body which is able to be handled upon formation.

Generally as the viscosity of the plastically deformable material is lowered, the wet, formed structure or article tends to collapse due to insufficient self-support. Conversely, as the viscosity of the plastically deformable material is increased to create self-support, forming of the material tends to require significantly higher forming pressure which in turn means that it becomes necessary to use heavier equipment, more substantial forming members and abrasion resistant parts.

Plastically deformable materials of the type described also typically include an organic binder component having a thermal gel point. As the temperature is increased toward the gel point, the viscosity of such materials decreases but when the gel point is reached there is a very rapid increase in the viscosity with increasing temperature. Therefore, plastically deformable materials of this kind tend to be worked and formed at temperatures just below the gel point of the organic binder.

Taking advantage of this gelling reaction, it has been proposed in U.S. Pat. No. 5,223,188 to use RF or radio frequency energy to heat a structure formed from a plasticized material to provide improved wet strength for better handling and processing capabilities. However, challenges exist in applying RF energy uniformly to the extruded structure, preventing the formation of extrudate skin defects, and controlling radiation leakage. Therefore, there exists the need for an improved system and method for uniformly heating a continuously moving, wet ceramic extrudate to provide improved handling before drying and firing.

### SUMMARY OF THE INVENTION

There is provided an apparatus and process for applying microwaves to stiffen a newly formed ceramic extruded structure for providing substantially improved wet strength and handling prior to drying and firing. The apparatus includes a microwave source for producing energy in the frequency range of 100 MHz to 30 GHz; a microwave applicator comprising a chamber having a flow axis, an inlet, an outlet, and a support for transporting the extruded ceramic body along the flow axis. The microwave applicator receives microwaves from the microwave source through a single waveguide feed. The inventive apparatus which is provided adjacent the die end of an extruder, supplies substantially greater continuous and substantially uniform circumferential volumetric heating to the wet ceramic body than standard methods.

The invention is applicable to any plastically deformable material which is capable of being molded and shaped by extrusion. Such materials include mixtures of inorganic powders (i.e., ceramic raw materials) and organic forming compounds (i.e., binders, surfactants, plasticizers, lubricants, and the like). At least one organic compound has a thermal gel point, this typically being a binder component. Particularly suitable plastic materials are mixtures capable of forming ceramic articles which contain cordierite and/or mullite. Examples of such mixtures being 2% to 60% mullite, and 30% to 97% cordierite, with allowance for other phases, typically up to 10% by weight. Some ceramic batch material compositions for forming cordierite are disclosed in U.S. Pat. No. 3,885,977. Suitable binders for cordierite formation which have a thermal gel point are cellulose ether binders, such as methylcellulose, and/or methylcellulose derivatives.

The ceramic raw materials, binder and remaining organic components are mixed with a liquid vehicle, generally water, to form a plasticized batch. The batch is then extruded through a die. Extruders are well known in the art, and can comprise a ram or a screw feed that forces the material through the die. As the ceramic material leaves the extruder die it is in the shape of a long tubular mass, referred to as a “log” which is then cut to shape. The invention is particularly suited to the process of extruding ceramic substrates. In past practice, the as-extruded log has a generally low wet strength, and is not generally firmly self supporting due to very thin webs. This makes the log difficult to handle in later processing steps (i.e., wet handling, cutting, and drying) without causing damage, such as through deformation.

According to the invention, after leaving the extrusion die, the ceramic log enters a field of microwave energy. The log is exposed to microwaves, while being conveyed at a rate sufficient to heat above the gel point of the binder. This causes the wet ceramic body to stiffen, thereby preventing sagging or handling deformation which is likely to occur when the shaped body has a low wet strength and is therefore not wholly self-supporting. Gelling in the organic binder occurs due to cross-linking of the polymer chains as known in the art. However, there is substantially no evaporation or water loss which occurs in ceramic bodies stiffened according to the present invention. This is an important advantage of this invention as it therefore prevents defects associated with shrinkage. The invention also allows for a more efficient and less costly ceramic substrate forming process.

### BRIEF DESCRIPTION OF THE DRAWINGS

The invention may be further understood with reference to the following drawings, wherein:

FIG. 1 is a schematic representation showing generally the microwave stiffening system according to the present invention;

FIG. 2 is a perspective view of an embodiment of a microwave applicator with a chamber composed of a modified rectangular waveguide;

FIG. 3 is a cross-sectional view illustrated along line 3-3 of the embodiment of FIG. 2;

FIG. 4 is a cross-sectional view illustrated along line 5-5 of the embodiment of FIG. 2;

FIG. 5 is a top view of the outlet end of the microwave applicator of FIG. 2 showing attenuation means;

FIG. 6 is a bar graph showing the effect of microwave heating on a cordierite honeycomb structure having a cell density of 600 cells per square inch and 0.004 inch thick cell walls;

FIG. 7 is a perspective view of another embodiment of a microwave applicator with a chamber composed of first and second cylindrical sections arranged in a diametrically stepped geometry;

FIG. 8 is a cross-sectional view illustrated along the line 8-8 of the embodiment of FIG. 7; and,

FIG. 9 is a cross-sectional view illustrated along the line 9-9 of the embodiment of FIG. 7.

### DETAILED DESCRIPTION OF THE INVENTION

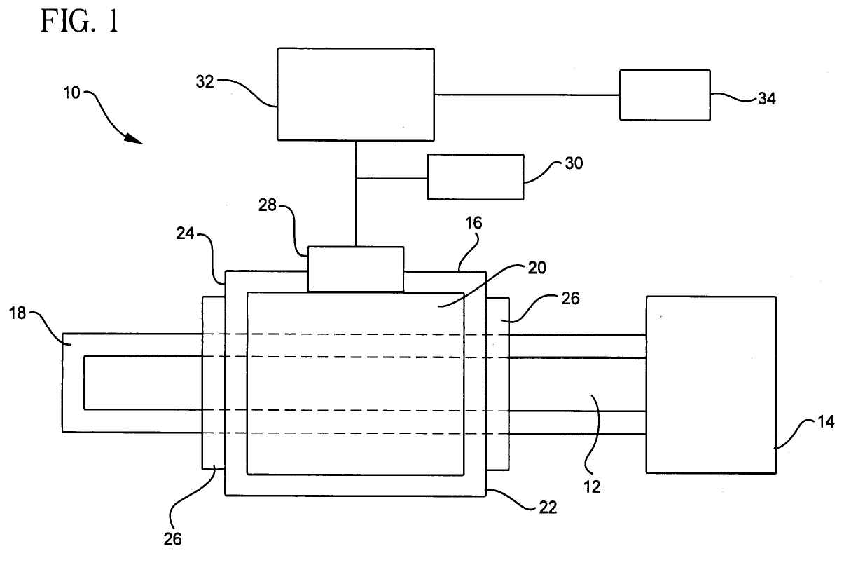

FIG. 1 illustrates the main features of the invention in a schematic fashion for a microwave stiffening system 10. A ceramic log 12 leaves a forming member or extruder 14 and is conveyed through a microwave applicator 16. Accordingly, the microwave applicator 16 is located at the exit or die end of the extruder 14 such that immediately upon being formed by the die member the ceramic log 12 is exposed to a field of microwave energy.

The microwave applicator 16 includes a chamber 20 and a single waveguide feed 28. Chamber 20 is outfitted with an inlet end 22 and an outlet end 24 in combination with a support 18 for carrying the log 12. Support 18 relates to any means as known in the art for continuously moving bodies, and preferably includes an air bearing system comprising a series of air bearing support chambers that are each supplied with air through individual conduits each of which is connected to a common air supply pipe, as described in U.S. Pat. No. 5,205,991 which is herein incorporated by reference in its entirety.

A single waveguide feed 28 is provided in communication with the microwave source 32 for receiving microwaves into the microwave applicator 16. A single waveguide feed is advantageous in the inventive apparatus for design simplification and cost reduction.

Attenuation means 26 are generally provided when necessary to reduce microwave radiation leakage at the inlet 22 and outlet 24 ends. Means for reducing microwave radiation are well known in the art, and can include microwave attenuators and chokes. Impedance matching means 30 are generally also provided between the microwave source 32 and the waveguide feed 28 to stop the reflection of microwave energy in a reverse direction. Such suitable devices include circulators and stub tuners as known in the art.

The microwave source 32 transmits microwaves in frequency range of 100 MHz to 30 GHz. The microwave source 32 can include any appropriate source such as a magnetron, klystron, traveling wave tubes, oscillator and the like. The system is also generally provided with a power supply and controller 34 for controlling and adjusting the microwave radiation delivered to the microwave applicator 16. The microwave energy is provided in a succession of TE_{xy} and/or TM_{xy} waveguide modes, where x is between 0 and 8, and y is between 1 and 3.

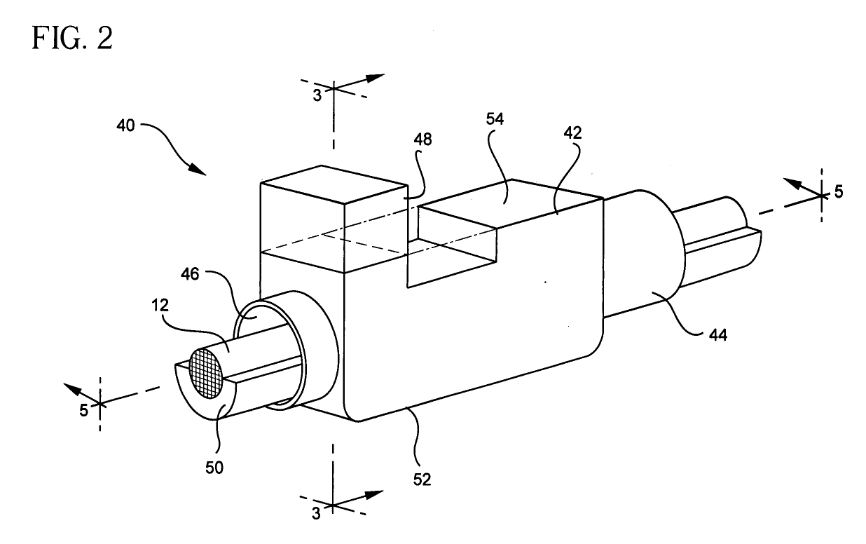

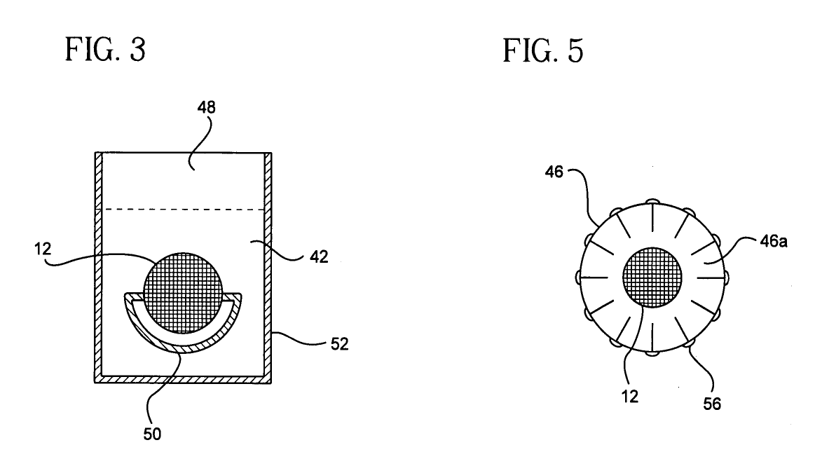

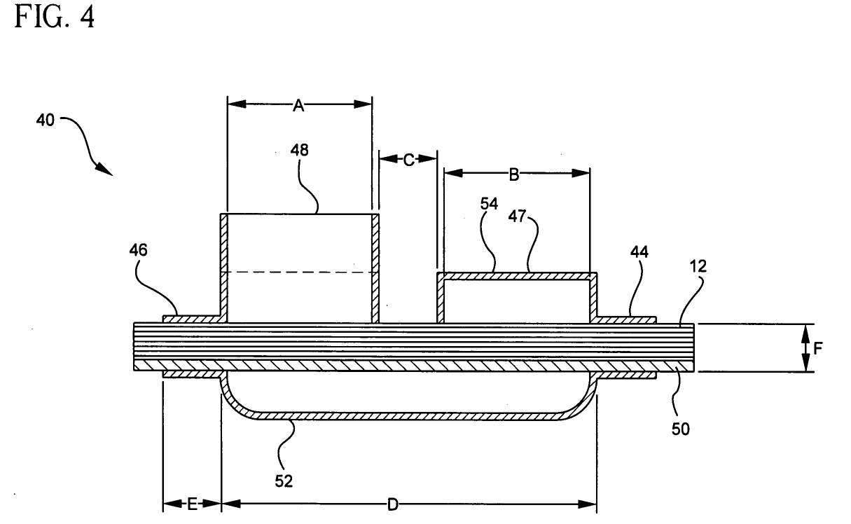

FIG. 2 illustrates an embodiment of a microwave applicator 40 suitable for the microwave stiffening system of the invention. FIGS. 3 and 4 illustrate cross-sectional views taken along lines 3-3 and 5-5 respectively. Microwave applicator 40 comprises a chamber 42 composed of a rectangular waveguide 52 bent along its length at two 90° angles such as in the shape of a “U”-structure. It is also contemplated that a square waveguide with a square waveguide feed would also be suitable in the present invention.

In operation most of the microwave energy is supplied to the ceramic log 12 in two 90° turns. In the first turn microwave energy enters the chamber through the microwave feed 48, passes through the ceramic log 12 doubles back on it self, where it is then reflected by the short at 54. The short 54 serves to reflect the power back into the 90° turns, thereby taking a second pass through the ceramic log 12. The microwave energy is provided in the TE₁₁ waveguide mode at the ceramic log inlet and outlet.

Cylindrical inlet 44 and outlet 46 ends allow for passage of ceramic log 12 through chamber 42. Ceramic log 12 is shown to be conveyed via an air bearing support 50 as discussed above. Inlet 44 and outlet 46 ends are preferably outfitted with attenuation means 56 as shown in FIG. 5 (only shown for outlet end 46). Attenuation means 56 include three parallel rows of screws extending in the cavity 46a of the outlet end 46 to surround the ceramic log 12 exiting there through. This simple arrangement has been found to be an effective method of reducing microwave radiation in the present invention. A microwave input port is provided at 48.

A laboratory-scale microwave stiffening apparatus having the following dimensions was built and tested on extruded cordierite-forming material. In FIG. 4, A=0.257 m, B=0.257 m, C=0.096 m, D=0.610 m, E=0.102 m, and F=0.154 m. The microwave source is a magnetron having a frequency of 2.45 GHz and a 1.8 kW power source, such as models available from ASTeX®. The cordierite-forming material was extruded through a honeycomb-forming die to form a tubular log with a traverse cross section of substantially round dimensions with major and minor axes of about 1.5 inches, and a cellular density of 600 cells per square inch and 0.004 inch thick cell walls. For experimental purposes as the ceramic log exited the extruder die it is passed through the microwave applicator at a feed rate of 40 lbs/hour. The power source is varied to between approximately zero watts (no microwave stiffening) to 600 watts. The stiffness of the ceramic log is measured using the ball drop test. This test involves dropping a rounded weight onto a supported wet honeycomb structure. The depth to which the weight sinks into the body is measured. High readings indicate a soft body, and low readings a stiffer body.

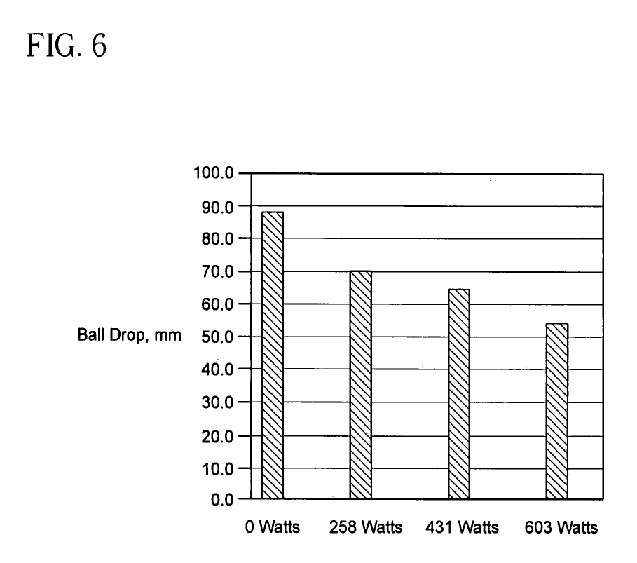

Referring now to FIG. 6 therein shown are the results for the ball drop testing, as indicated in mm, as a function of power level, as indicated in watts. As the power to the microwave applicator is increased, the ball drop measurements decrease indicative of a stiffer material. Ball drop decreases by 35% at about 600 watts indicating significant increase in the stiffness of the ceramic extruded log.

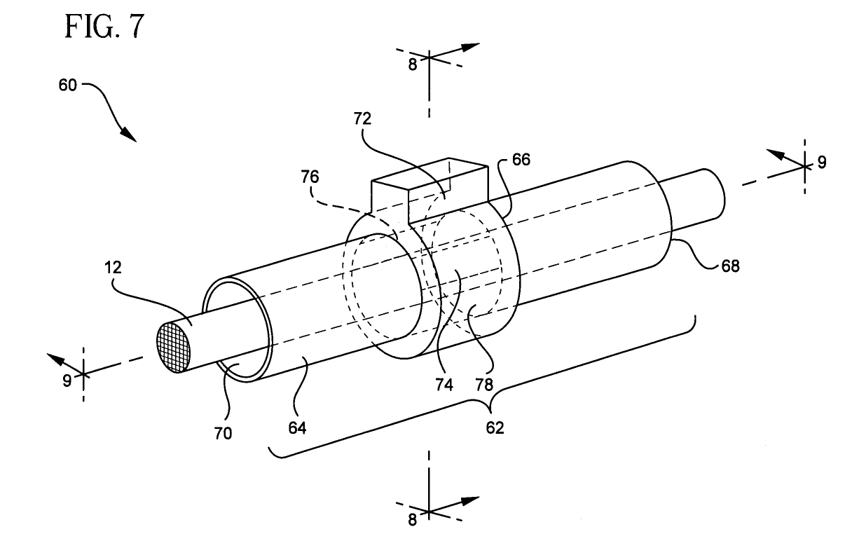

Using both Finite Difference Time Domain (FDTD) method which is based on an electromagnetic modeling algorithm, and a visualization software, such as Tecplot, a microwave stiffening system can be fully designed based on dielectric properties of the ceramic extruded material, the dimensions of the microwave applicator (from FIG. 4), and an application of a frequency of 915 MHz. Accordingly, another embodiment in accordance with present invention is illustrated in FIGS. 7-9.

A microwave applicator 60 comprises a chamber 62 which transforms microwave energy from the microwave source into a cylindrical waveguide mode. As shown, chamber 62 is composed of an inner 64 cylindrical section and an outer 66 cylindrical section of larger diameter. The outer cylindrical section 66 surrounds inner cylindrical section 64 to create a diametrically stepped geometry. Inner cylindrical section 64 receives and exits ceramic log 12 at inlet 68 and outlet 70 ends, respectively.

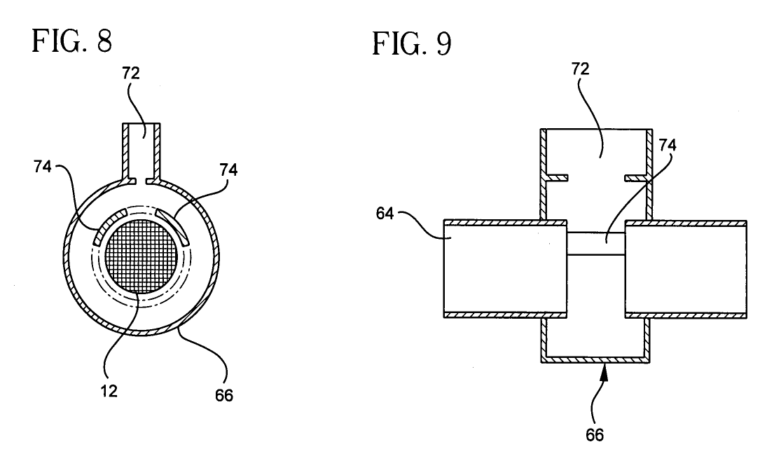

Outer cylindrical section 66 includes waveguide feed 72 for receiving microwaves into chamber 62. Portions of the inner cylindrical section 64 are cut along the circumference thereof to form a pair of adjacent curvi-planar segments 74, as shown in FIG. 8. A first cut-out portion 76 is adjacent and corresponds to waveguide feed 72. A second cut-out portion 78 extends between curvi-planar segments 74. The curvi-planar segments 74 are long enough to shield a half-wavelength section of the ceramic log 12, measured from the center of the first cut-out portion 76.

The function of the curvi-planar segments 74 is to evenly distribute microwave energy entering cylindrical waveguide 62 such as to provide uniform circumferential heating of ceramic log 12. Specifically, as microwaves are transmitted through microwave input port 72, a portion thereof enters through first cut-out 76, while the remaining is deflected by planar segments 74 to enter second cut-out 78, for uniform circumferential heating. The modeling simulations shows that the microwave energy is provided in a succession of TEₓ₁ waveguide modes, where x is between 3 and 4, so as to more evenly distribute the concentrations of microwave energy to the ceramic log. To excite these higher order modes the diameter of the outer cylindrical section 66 is scaled to the thickness of waveguide.

A person of ordinary skill in the art will appreciate further features and advantages of the invention based on the above-described embodiments. Accordingly, the invention is not limited by what has been particularly shown and described, except as indicated in the appended claims.

1. A microwave system for stiffening a wet ceramic body comprising:
a microwave source for producing energy in the frequency range of 100 MHz to 30 GHz;
a microwave applicator comprising:
a chamber having a flow axis, an inlet, an outlet, and a support for transporting the extruded ceramic body along the flow axis, and,
a single waveguide feed for receiving microwaves from the microwave source,
wherein the microwave system is provided adjacent a die end of an extruder by which the ceramic body is formed, such that as the wet ceramic body leaves the extruder it immediately enters a field of microwaves.

2. A microwave system in accordance with claim 1 further comprising microwave attenuation means at the inlet or the outlet, or both of the chamber of the microwave applicator.

3. A microwave system in accordance with claim 2 further comprising impedance matching means provided between the single waveguide feed and the microwave source.

4. A microwave system in accordance with claim 3 wherein the impedance matching means include circulators and stub tuners.

5. A microwave system in accordance with claim 1 wherein the microwave energy is provided in a succession of TE_{xy} and/or TM_{xy} waveguide modes, where x is between 0 and 8, and y is between 1 and 3.

6. A microwave system in accordance with claim 1 wherein the chamber is composed of rectangular or square waveguide bent along its length at two 90° angles to form a “U”-shaped structure.

7. A microwave system in accordance with claim 6 wherein the inlet and outlet of the chamber are cylindrical.

8. A microwave system in accordance with claim 4 wherein the microwave applicator operates in the TEₓ₁ waveguide mode.

9. A microwave system in accordance with claim 1 wherein the chamber is composed of an inner cylindrical section, and an outer cylindrical section of larger diameter surrounding the inner cylindrical section in a diametrically stepped geometry;
wherein the outer cylindrical section includes the single waveguide feed;
wherein portions of the inner cylindrical section are cut-out to form a pair of adjacent curvi-planar segments, such that a first cut-out is adjacent the waveguide feed at the outer cylindrical section, and a second cut-out extends between the curvi-planar segments.

10. A microwave system in accordance with claim 9 wherein the microwave applicator operates in a succession of TEₓ₁ waveguide modes, where x is between 3 and 4.

11-12. (canceled)
